(19) United States
(12) Patent Application Publication
(10) Pub. No.: US 2007/0119871 A1
(43) Pub. Date: May 31, 2007

(54) Fastener cartridge

(76) Inventor: Saddy R. Garcia, St. Augustine, FL (US)

Correspondence Address: HARNESS, DICKEY & PIERCE, P.L.C., P.O. BOX 828, BLOOMFIELD HILLS, MI, 48303, US

(21) Appl. No.: 11/593,446

(22) Filed: Nov. 6, 2006

Related U.S. Application Data
(60) Provisional application No. 60/734,340, filed on Nov. 7, 2005.

(51) Int. Cl. G01F 11/00

(52) U.S. Cl. 222/325

(57) ABSTRACT

A fastener cartridge may include a fastener housing, a fastener, and a retaining member. The fastener housing may include a fastener seat. The fastener may include a head supported on said fastener seat and a shank extending therefrom. The retaining member may extend into the fastener housing and engage the fastener head, generally securing the fastener head between the fastener seat and the retaining member. The fastener cartridge may additionally include an alignment feature forming in an opening of the fastener housing. The alignment feature may correspond to a predetermined orientation of the fastener and may be configured to provide alignment between a driver and the fastener.

### CROSS-REFERENCE TO RELATED APPLICATIONS

This application claims the benefit of U.S. Provisional Application No. 60/734,340, filed on Nov. 7, 2005, the disclosure of which is incorporated herein by reference in its entirety.

### FIELD

The present teachings relate to cartridges, and more specifically to fastener cartridges.

### BACKGROUND

Fastener cartridges typically include some form of chamber having a cap for retaining a fastener therein. Typically, alignment of the fastener within the cartridge with a driver must be done manually. This can often be difficult when working with small fasteners.

### SUMMARY

Accordingly, a fastener cartridge may include a fastener housing, a fastener, and a retaining member. The fastener housing may include a fastener seat. The fastener may include a head supported on said fastener seat and a shank extending therefrom. The retaining member may extend into the fastener housing and engage the fastener head, generally securing the fastener head between the fastener seat and the retaining member.

The fastener cartridge may additionally include an alignment feature forming in an opening of the fastener housing. The alignment feature may correspond to a predetermined orientation of the fastener and may be configured to provide alignment between a driver and the fastener.

Further areas of applicability of the present teachings will become apparent from the detailed description provided hereinafter. It should be understood that the detailed description and specific examples are intended for purposes of illustration only and are not intended to limit the scope of the present teachings.

### BRIEF DESCRIPTION OF THE DRAWINGS

The present teachings will become more fully understood from the detailed description and the accompanying drawings, wherein:

FIG. 1 is a perspective view of a driver and a fastener cartridge with the fastener removed;

FIG. 2 is a front plan view of the fastener cartridge of FIG. 1 with a fastener contained therein;

FIG. 3 is a fragmentary sectional view of the fastener cartridge of FIG. 2;

FIG. 4 is a fragmentary sectional view of the fastener cartridge of FIG. 3 with a driver displacing the retaining member to an unlocked position;

FIG. 5 is a perspective view of an alternate fastener cartridge with a fastener contained therein;

FIG. 6 is a fragmentary sectional view of the fastener cartridge of FIG. 5;

FIG. 7 is a fragmentary sectional view of the fastener cartridge of FIG. 6 with a driver displacing the retaining member to an unlocked position;

FIG. 8 is a perspective view of an alternate fastener cartridge with a fastener contained therein;

FIG. 9 is a sectional view of the fastener cartridge of FIG. 8;

FIG. 10 is the sectional view of the fastener cartridge of FIG. 9 with a driver displacing the retaining member to an unlocked position;

FIG. 11 is a perspective view of an alternate fastener cartridge with a fastener contained therein;

FIG. 12 is a fragmentary sectional view of the fastener cartridge of FIG. 11;

FIG. 13 is a fragmentary sectional view of the fastener cartridge of FIG. 12 with a driver displacing the retaining member to an unlocked position;

FIG. 14 is a perspective view of an alternate fastener cartridge with a fastener contained therein;

FIG. 15 is a sectional view of the fastener cartridge of FIG. 14;

FIG. 16 is the sectional view of the fastener cartridge of FIG. 15 with a driver displacing the retaining member to an unlocked position;

FIG. 17 is a perspective view of an alternate fastener cartridge with a fastener contained therein;

FIG. 18 is a fragmentary sectional view of the fastener cartridge of FIG. 17;

FIG. 19 is a fragmentary sectional view of the fastener cartridge of FIG. 18 with a driver displacing the retaining member to an unlocked position; and

FIG. 20 is a fragmentary sectional view of an alternate fastener cartridge with a fastener contained therein.

### DETAILED DESCRIPTION

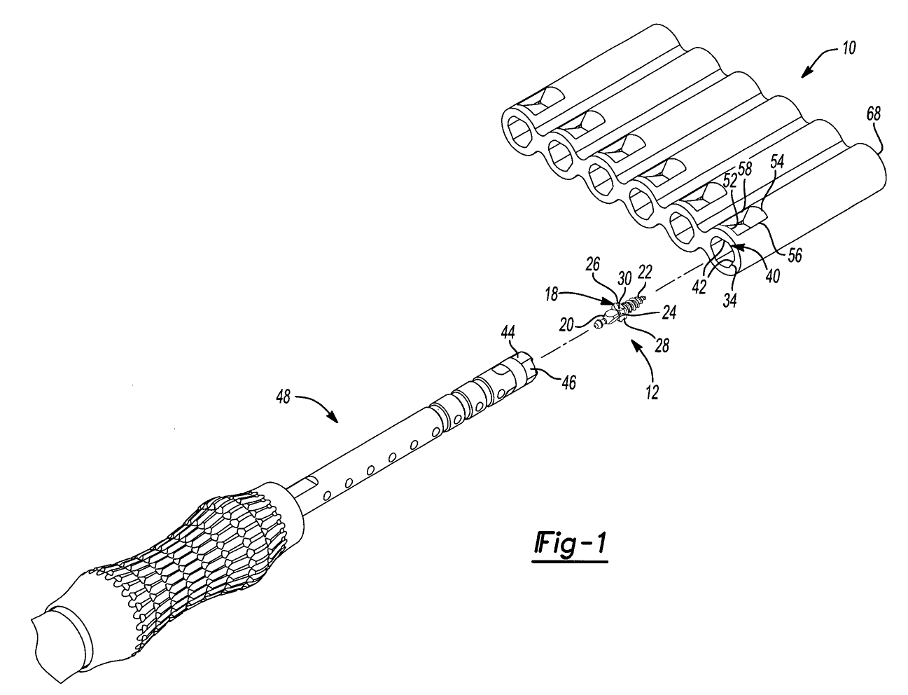

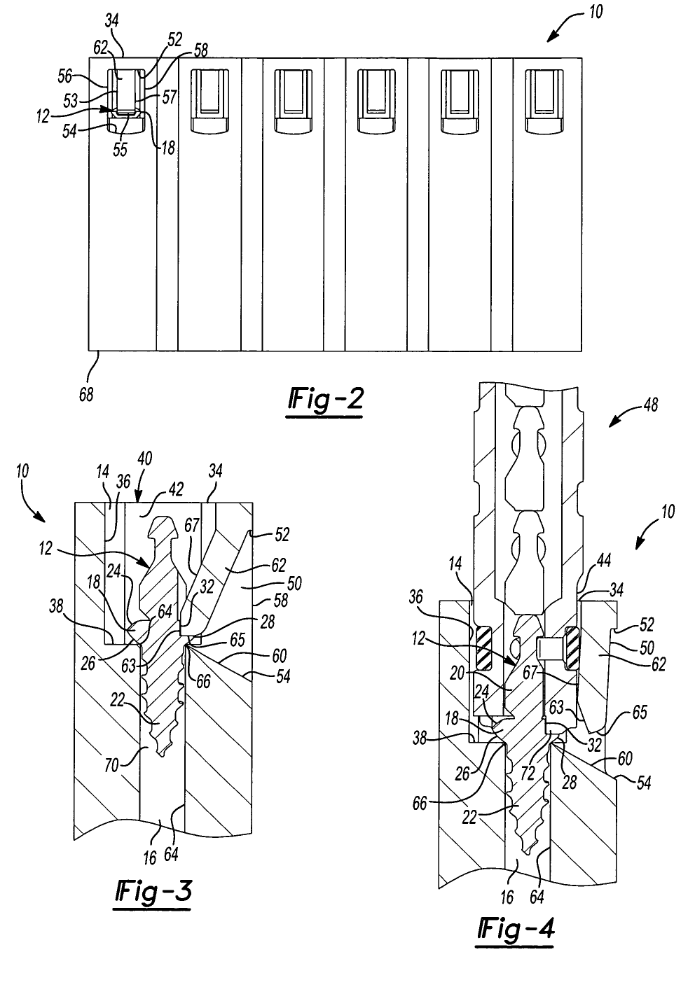

The following description is merely exemplary in nature and is not intended to limit the present disclosure, application, or uses. FIGS. 1-4 show a fastener cartridge 10 that may generally house a fastener 12. The fastener cartridge 10 may include a housing having first and second chambers 14,16.

The fastener 12 may generally include a head 18, a post 20 and a shank 22. The head 18 may include an upper surface 24, a lower surface 26 and a perimeter portion 28. The upper surface 24 may have post 20 generally extending therefrom. The lower surface 26 may have shank 22 generally extending therefrom. The upper surface 24 may include a driving geometry 30 near the perimeter portion 28. The driving geometry 30 may include arcuate recesses 32. While fastener 12 is shown including a post 20 extending from head 18, it is understood that alternate fasteners without posts may be used as well.

The first chamber 14 may include an open top portion 34, an inner sidewall 36 and a lower surface 38. The open top portion 34 may generally define a top to the fastener cartridge 10. The inner sidewall 36 may include an alignment feature 40, which is shown to include a series of flats 42. The flats 42 may generally correspond to flats 44 on outer profile 46 of a driver 48. The flats 42, 44 may generally orient the driver 48 within first chamber 14. While shown as a series of flats 42, 44, it should be understood that other features could be formed on inner sidewall 36 and driver 48 to provide alignment.

The inner sidewall 36 may also include a window 50 which may generally have upper, lower, left and right sides 52, 54, 56, 58. Lower side 54 may include a sloped surface 60. A retaining member 62 may be integrally formed with and generally extend from upper side 52. The retaining member 62 may have free sides 53, 55, 57. The retaining member 62 may generally include a radially innermost surface 63, an end surface 65 and an angled inner surface 67. The retaining member 62 may normally extend radially inwardly from inner sidewall 36. However, retaining member 62 may be displaced radially outwardly, as will be discussed below.

The lower surface 38 may form a fastener seat including an aperture 64 therethrough. The aperture 64 may be generally centered on lower surface 38. The aperture 64 may provide communication between the first and second chambers 14, 16, as well as centering fastener 12 within fastener cartridge 10.

The second chamber 16 may be generally located beneath first chamber 14. The second chamber 16 may be open at first and second ends 66, 68. The first end 66 may be generally open at aperture 64. The second end 68 may generally define a bottom of fastener cartridge 10. The main portion 70 of second chamber 16 may generally be in the form of a cylindrical passage. The main portion 70 may have a diameter generally equal to the diameter of aperture 64.

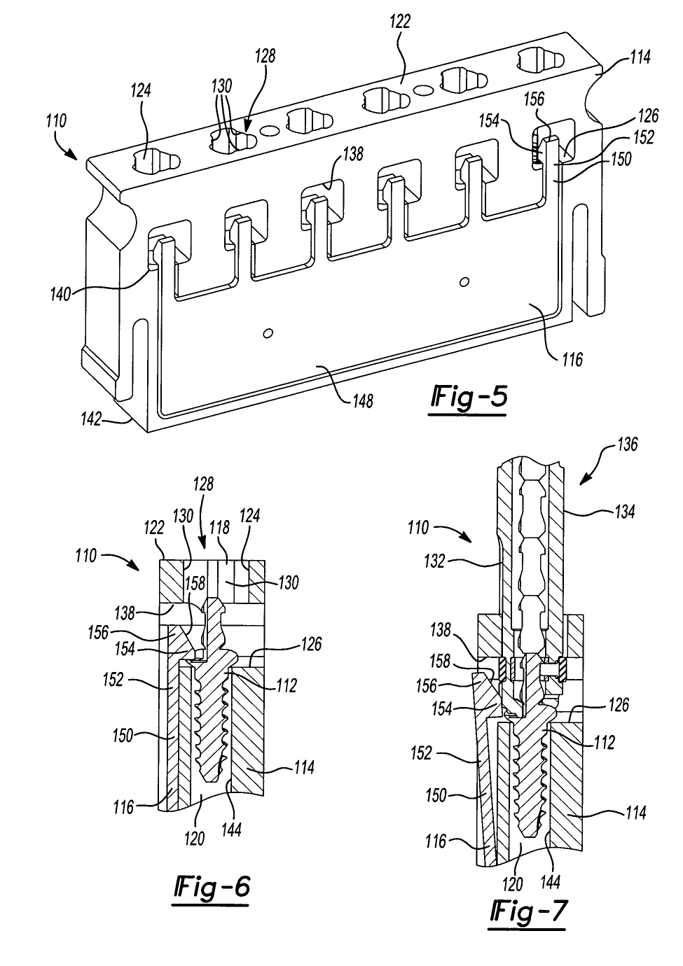

FIGS. 5-7 show an alternate fastener cartridge 110 that may generally house a fastener 112. The fastener cartridge 110 may include first and second members 114, 116. Fastener 112 may be generally similar to fastener 12 and therefore will not be described in detail.

First member 114 may generally form a housing member and second member 116 may generally form a retaining member. First member 114 may include first and second chambers 118, 120. First chamber 118 may include an open top portion 122, an inner sidewall 124, and a lower surface 126 forming a fastener seat. Open top portion 122 may generally define a top to fastener cartridge 110. Inner sidewall 124 may include an alignment feature 128, which is shown as a series of radially inwardly extending protrusions 130. Protrusions 130 may have an arcuate shape and may generally conform to arcuate recesses 132 on an outer surface 134 of a driver 136. While shown as a series of protrusions 130, it is understood that alternate features may be formed on inner sidewall 124 and/or open top portion 122 to provide alignment between driver 136 and fastener cartridge 110. Inner sidewall 124 may additionally include a window 138 formed therein.

Second chamber 120 may extend below first chamber 118 and may be open at first and second ends 140, 142. Second chamber 120 may also include a sidewall 144 having a window 146 formed therein. Second member 116 may be coupled to first member 114 and may generally cover window 146.

Second member 116 may include a main body portion 148 having fingers 150 extending therefrom. Main body portion 148 may be fixed to first member 114 and fingers 150 may extend freely therefrom and into window 138. Fingers 150 may include an elongate body 152 having a protrusion 154 extending radially inwardly from an end portion 156 thereof for engagement with fastener 112. End portion 156 may extend into first chamber 118 and may include a ramped surface 158 to cause radially outward displacement thereof when engaged by a driver 136.

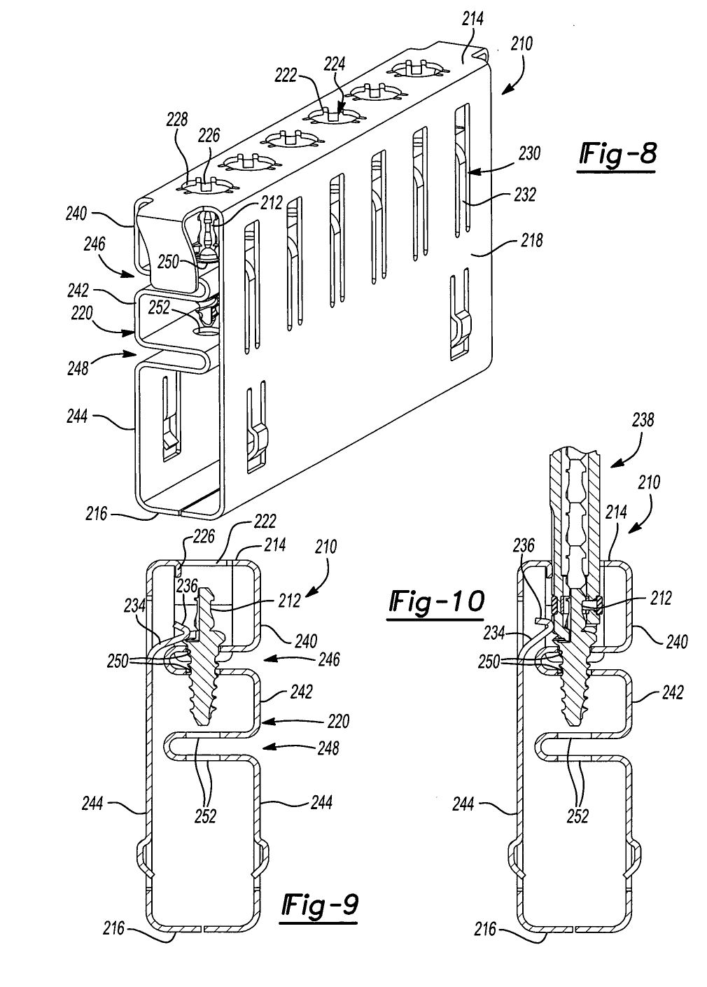

FIGS. 8-10 show an alternate fastener cartridge 210 that may generally house a fastener 212, generally similar to fastener 112. Fastener cartridge 210 may be formed from a single piece of sheet metal and may include upper and lower portions 214, 216 and sidewalls 218, 220. Upper portion 214 may include a series of apertures 222 having alignment features 224 thereon. Alignment features 224 may include tabs 226 extending radially inward and axially downward from an outer perimeter 228 thereof.

Sidewall 218 may include a series of retaining members 230 extending therefrom. Retaining member 230 may be formed in sidewall 218. Retaining member 230 may include an axially extending portion 232 and a radially inwardly extending portion 234. Axially extending portion 232 may generally extend within the plane of sidewall 218. Radially inwardly extending portion 234 may engage fastener 212. Radially inwardly extending portion 234 may include a ramped end 236 to cause radially outward displacement thereof when engaged by a driver 238.

Sidewall 220 may be separated into first, second, and third regions 240, 242, 244. The sheet metal forming sidewall 220 may be bent inwardly between first and second regions 240, 242 and between second and third regions 242, 244, creating first and second fastener housing members 246, 248 extending inwardly therefrom. First fastener housing member 246 may be located below radially inwardly extending portion 234 and may include apertures 250 therethrough and may form a seat for fastener 212. Second fastener housing member 248 may be located below first fastener housing member 246 and may include apertures 252 therethrough generally aligned with apertures 250.

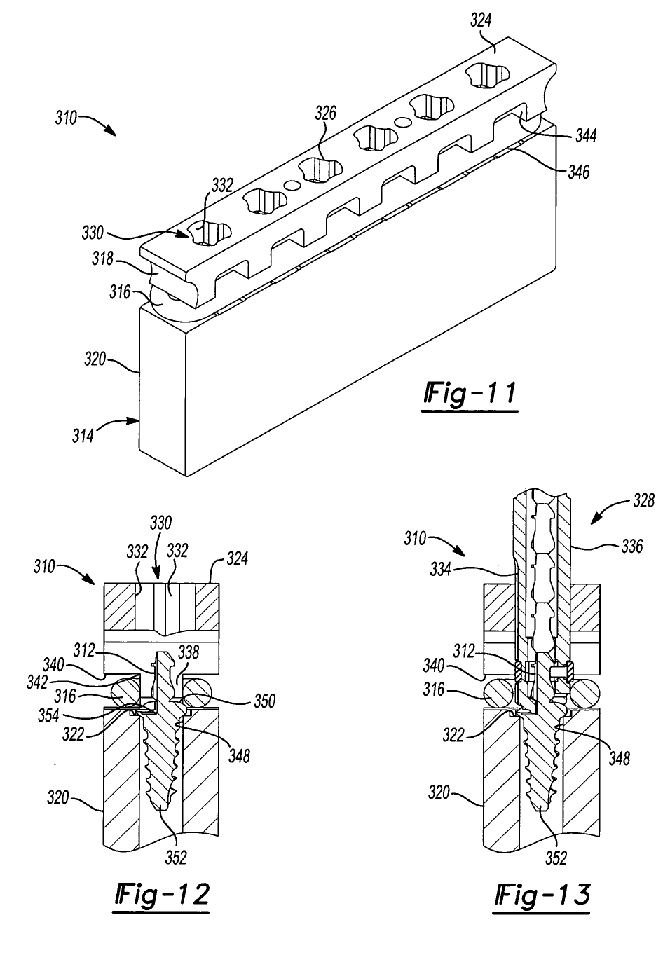

An alternate fastener cartridge 310 housing a fastener 312 is shown in FIGS. 11-13. Fastener cartridge 310 may include a housing 314 and a retaining member 316. Housing 314 may include first and second portions 318, 320 and a fastener seat 322 disposed therebetween. First portion 318 may include an upper portion 324 including openings 326 for receiving a driver 328 therein. Openings 326 may include an alignment feature 330, which is shown as a series of radially inwardly extending protrusions 332. Protrusions may have an arcuate shape and may generally conform to arcuate recesses 334 on an outer surface 336 of driver 328 providing alignment therebetween.

First portion 318 may further include a series of supports 338 extending from a lower surface 340 thereof to fastener seat 322. Supports 338 may be spaced apart from one another and may have a width less than a width of both first and second portions 318, 320, forming a recessed path 342 along a perimeter thereof. Due to the spaced relationship, supports 338 may form windows 344 in first portion 318.

Fastener seat 322 may form an upper surface of second portion 320. Fastener seat 322 may include a series of recessed portions 346 having apertures 348 passing therethrough. Apertures 348 may extend into second portion 320. Fastener head 350 may be supported on fastener seat 322 and shank 352 may extend through aperture 348.

Retaining member 316 may extend around recessed path 342 and over a portion of fastener head 350, axially retaining fastener 312 within housing 314. Retaining member 316 may further engage a recess 354 formed in fastener head 350 to provide rotational orientation of fastener 312 relative to housing 314. Retaining member 316 may take a variety of forms including an o-ring and an o-spring (or balseal spring).

Fastener cartridges 10, 110, 210, 310 may each house a plurality of fasteners. Alternatively, fastener cartridges may be provided for individual fasteners. However, the fastener cartridges discussed below and shown as housing a single fastener may be grouped together to house multiple fasteners as well.

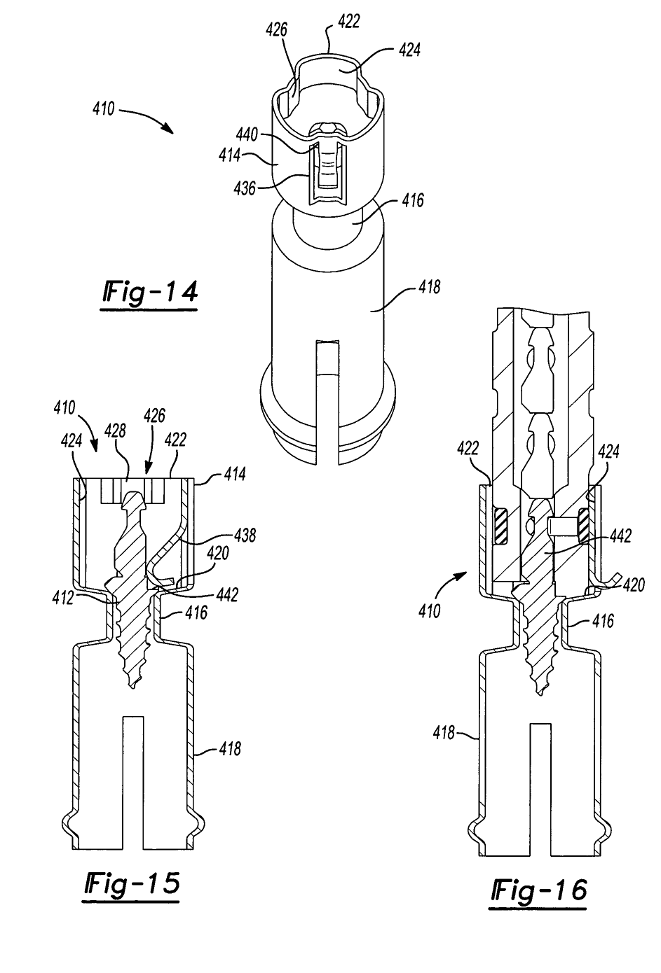

For example, FIGS. 14-16 show a fastener cartridge 410 for housing an individual fastener 412. The fastener 412 may be generally similar to fastener 112 and therefore will not be described in detail. Fastener cartridge 410 may be formed as a single piece including first, second, and third portions 414, 416, 418. First and second portions 414, 418 may have diameters generally similar to one another and second portion 416 may have a diameter smaller than the diameter of first and second portions 414, 418. A stepped portion 420 may therefore be formed between first and second portions 414, 416, forming a fastener seat.

First portion 414 may include an open end 422 and a sidewall 424. Sidewall 424 may include an alignment feature 426 near open end 422. Alignment feature 426 may include radially inwardly extending protrusions 428 conforming to a recess 430 on an outer surface 432 of a driver 434. Sidewall 424 may additionally include a series of windows 436 extending therethrough below alignment feature 426. One of windows 436 may include a retaining member 438 extending from an upper edge 440 thereof. Retaining member 438 may extend radially inwardly for engagement with a recessed portion 442 of fastener 412, as discussed below.

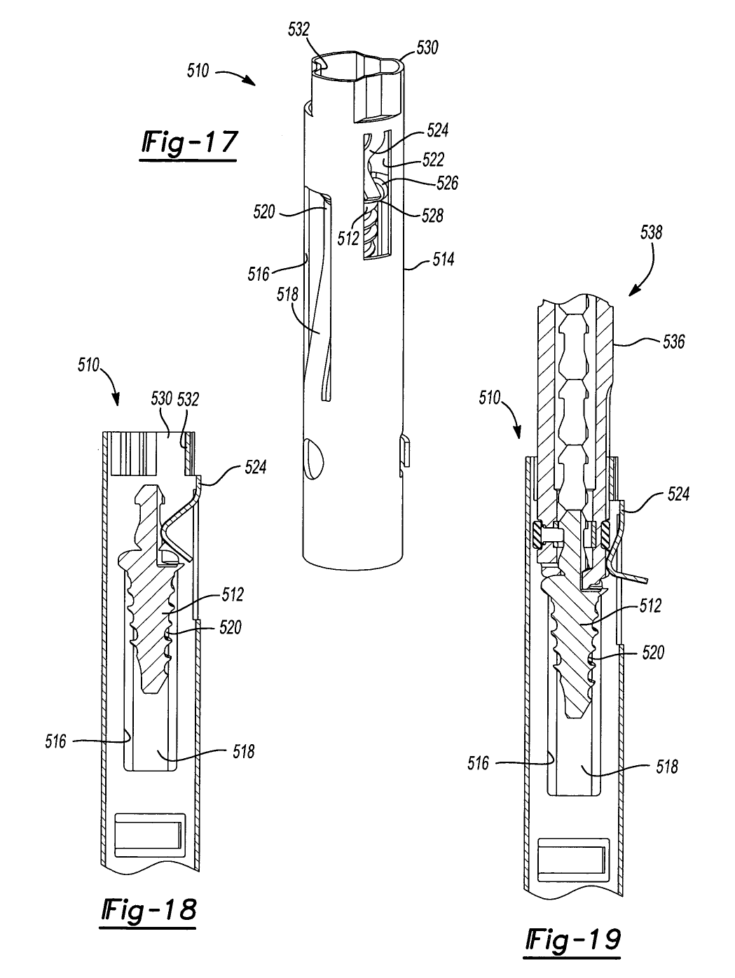

An alternate fastener cartridge 510 housing a fastener 512 is shown in FIGS. 17-19. Fastener 512 may be generally similar to fastener 112 and therefore will not be discussed in detail. Fastener cartridge 510 may include a generally cylindrical body 514 having a series of windows 516 with tabs 518 extending axially and radially inwardly therefrom. Tabs 518 may include ends 520 forming a fastener seat. An additional window 522 may be located near tab ends 520 and may include a retaining member 524 extending axially and radially inwardly from an upper edge thereof.

Tab ends 520 may engage a lower portion of a head 526 of fastener 512 and retaining member 524 may engage an upper portion of fastener head 526, axially trapping fastener 512 therebetween. More specifically, retaining member 524 may extend into a recess 528 in fastener head 526, inhibiting rotation of fastener 512 relative to fastener cartridge body 514.

An end of fastener cartridge body 514 above fastener head 526 may include an alignment feature 530. Alignment feature 530 may be generally similar to the various alignment features previously discussed, including protrusions 532 corresponding to recesses 534 on an outer surface 536 of a driver 538. Retaining member 524 may rotationally orient fastener 512 relative to alignment features 530, providing alignment between driver 538 and fastener 512.

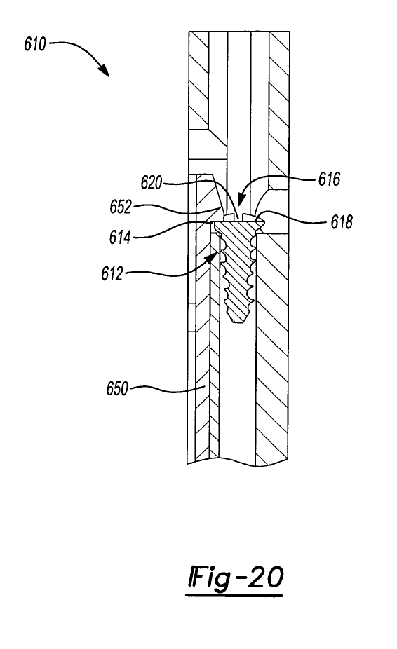

As indicated above and shown in FIG. 20, a fastener cartridge 610 may be generally similar to fastener cartridge 110, but may contain a fastener 612 having no post extending from a head 614 thereof. For simplicity fastener cartridge 610 will not be described in detail, with the understanding that the description of fastener cartridge 110 generally applies to fastener cartridge 610 as well.

Fastener 612 may have a cross-drive configuration 616 including intersecting slots 618, 620 extending across the width of fastener head 614. Slots 618, 620 may extend to an outer circumference of fastener head 614 and may provide a location for engagement with a retaining member, such as fingers 650. Fingers 650 may include protrusions 652 extending radially inwardly from an end 654 thereof. Protrusions 654 may be sized to fit within slots 618, 620 and may orient and retain fastener 612 in a manner generally similar to that disclosed above regarding fastener cartridge 110, and more specifically fingers 150.

Fastener cartridges 10, 110, 210, 310, 410, 510, 610 may operate generally similar to one another. Therefore, for simplicity, only the operation of fastener cartridge 10 will be described in detail with the understanding that the description applies equally to fastener cartridges 110, 210, 310, 410. In operation, the fastener cartridge 10 may retain fastener 12. The head 18 and post 20 of the fastener 12 may be contained within the first chamber 14. The shank 22 may primarily be contained within the second chamber 16.

The lower surface 26 of head 18 may generally seat against lower surface 38 of first chamber 14. The shank 22 may generally extend through aperture 64. Lower surface 38 may generally act as a stop, as the diameter of head 18 may be greater than the diameter of aperture 64, thereby preventing head 18 from passing through aperture 64. Arcuate recess 32 in head 18 may be generally aligned and engaged with retaining member 62. The radially innermost and lower surfaces 63, 65 may be in contact with recess 32. This contact may prevent fastener 12 from traveling axially in a direction toward open top portion 34 of first chamber 14. As a result of the interaction between the lower surface 38 and retaining member 62 of first chamber 14, fastener 12 may be retained within fastener cartridge 10. This retention may eliminate the need for any end caps on fastener cartridge 10.

The retaining member 62 may also orient fastener 12 within fastener cartridge 10. When retaining member 62 is in engagement with recess 32, fastener 12 may be generally prevented from rotating. This may be used to provide a fixed orientation for easier engagement with a driver 48. This may allow a fastener 12 to be arranged in a variety of predetermined orientations.

The alignment feature 40 may cooperate with retaining member 62 to generally align fastener 12 and driver 48, which eases alignment of smaller fasteners with driver 48. The driver 48 may engage fastener 12 without the need for manual removal of the fastener 12 and alignment with driver 48. When driver 48 is inserted into first chamber 14, the alignment feature 40 may orient driver 48 in a predetermined way, which generally aligns protrusions 72 of driver 48 with recesses 32 of fastener 12 through cooperation with retaining member 62.

The driver 48 may also release fastener 12 from within first chamber 14. As driver 48 enters first chamber 14, it may engage angled inner surface 67 of retaining member 62. As driver 48 travels axially into first chamber 14, retaining member 62 may be urged radially outwardly. As retaining member 62 is urged radially outwardly, it may be released from engagement with recess 32 in fastener head 18. Once released from engagement, fastener 12 may engage driver 48. Once engaged with driver 48, fastener 12 may travel axially outwardly toward open top portion 34 and out of fastener cartridge 10.

The description is merely exemplary in nature and, thus, variations are not to be regarded as a departure from the spirit and scope of the present teachings.

What is claimed is:

1. A fastener cartridge comprising:
a fastener housing including a fastener seat;
a fastener including a head and a shank, said head supported on said fastener seat; and
a retaining member extending into said fastener housing, engaging said fastener head, and generally securing said fastener head between said fastener seat and said retaining member.

2. The fastener cartridge of claim 1, wherein said retaining member extends above a portion of said fastener head to inhibit axial displacement of said fastener relative to said fastener housing.

3. The fastener cartridge of claim 1, wherein said fastener head includes a recess therein, said retaining member extending into said recess to inhibit rotation of said fastener relative to said fastener housing.

4. The fastener cartridge of claim 3, wherein said recess is located in an upper surface of said fastener head, said retaining member extending into said recess to inhibit axial displacement of said fastener relative to said fastener housing.

5. The fastener cartridge of claim 4, wherein said retaining member includes an arm having a first end fixed to said fastener housing and a second end being generally free.

6. The fastener cartridge of claim 5, wherein said first end is engaged with said recess in said fastener head.

7. The fastener cartridge of claim 5, wherein said fastener housing includes a window formed in a sidewall thereof, said retaining member extending from an edge of said window.

8. The fastener cartridge of claim 7, wherein said retaining member is integrally formed with said sidewall.

9. The fastener cartridge of claim 1, wherein a portion of said retaining member extends radially inwardly relative to an inner surface of a sidewall of said fastener housing.

10. The fastener cartridge of claim 1, wherein said fastener housing and said retaining member are integrally formed from a single piece of sheet metal.

11. The fastener cartridge of claim 1, wherein said retaining member is displaceable radially outwardly relative to said fastener housing.

12. The fastener cartridge of claim 1, wherein said fastener housing includes an alignment feature configured to align a driver with said fastener cartridge.

13. The fastener cartridge of claim 12, wherein said alignment feature includes a protrusion extending radially inwardly relative to a sidewall of said fastener housing.

14. A fastener cartridge comprising:
a fastener including a head and a shank; and
a fastener housing including an opening, a fastener seat, and an alignment feature, said fastener seat supporting said fastener head thereon in a predetermined orientation, said opening providing access to said fastener, said alignment feature corresponding to said predetermined orientation of said fastener and configured to provide alignment between a driver and said fastener.

15. The fastener cartridge of claim 14, wherein said alignment feature is formed on a sidewall of said fastener housing.

16. The fastener cartridge of claim 15, wherein said alignment feature includes a radially inwardly extending protrusion.

17. The fastener cartridge of claim 14, wherein said fastener head includes a recess therein and said fastener housing includes a second alignment feature configured to engage said recess in said fastener head to provide said predetermined orientation.

18. The fastener cartridge of claim 17, wherein said second alignment feature includes a retaining member engaged with said fastener head to inhibit axial displacement and rotation of said fastener relative to said fastener housing.

19. In a fastener cartridge comprising a fastener housing, a fastener, and a retaining member, the fastener housing including a fastener seat supporting a head of the fastener thereon, the retaining member being coupled to the fastener housing and engaged with the fastener head to provide a predetermined orientation of the fastener relative to the fastener housing, an opening in the fastener housing providing access to the fastener by a driver, and an alignment feature in the opening and generally corresponding to the predetermined orientation of the fastener to provide relative alignment between the driver and the fastener.

20. The fastener cartridge of claim 19, wherein the retaining member extends above the fastener head to inhibit axial displacement of the fastener relative to the fastener housing.
